(19) United States
(12) Patent Application Publication
(10) Pub. No.: US 2017/0021802 A1
(43) Pub. Date: Jan. 26, 2017

(54) Mobile application for vehicle alarm notices and related system

(71) Applicant: Titus Mims, Trenton, NJ (US)

(72) Inventor: Titus Mims, Trenton, NJ (US)

(21) Appl. No.: 15/214,654

(22) Filed: Jul. 20, 2016

Related U.S. Application Data
(60) Provisional application No. 62/195,324, filed on Jul. 22, 2015.

(51) Int. Cl. B60R 25/102; B60R 25/33; B60R 25/10

(52) U.S. Cl. CPC B60R 25/102; B60R 25/1003; B60R 25/33

(57) ABSTRACT

A mobile application for vehicle alarm notices and related system alerts the user to possible theft of their vehicle. The application may be downloaded and installed on the user's smartphone, tablet, or other mobile electronic device. A key fob, which contains a receiver and transmitter, is also provided as an alternate operating device. When the application is activated, if an unauthorized person is attempting to break into the user's vehicle, the vehicle transmits an alert notice to the user's devices. The user is then provided a brief, predetermined time period, such as 30 seconds, to deactivate the alert. If the alert is not deactivated by the user in this time period, both the vehicle and the user's devices transmit an alert to law enforcement.

### CROSS-REFERENCE TO RELATED APPLICATIONS

This Application claims the benefit of U.S. Provisional Application No. 62/195,324, filed Jul. 22, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to mobile applications and in particular to a mobile application for vehicle alarm notices and related system. Car thieves are becoming more and more sophisticated. Regardless of the advances in alarm systems and protection technology, the thieves quickly develop countermeasures. Clearly, the one form of defense that will be the most difficult for them to defeat is an alert, well-informed vehicle owner. Unauthorized use of a vehicle by family members, roommates, and acquaintances who somehow acquire a key to the vehicle is another problem in some households, and an alert system for the vehicle owner with a built-in notice provision to law enforcement would address both of these problems effectively. Unfortunately, the cost of purchasing and installing such an alert system as an after-market modification is very expensive. A mobile application for vehicle alarm notices and related system, which is inexpensively provided by the vehicle manufacturer and sends a notice to the vehicle owner's mobile electronic device shortly before notifying law enforcement, would resolve both of these problems.

### SUMMARY OF THE INVENTION

Accordingly, the invention is directed to a mobile application for vehicle alarm notices and related system. The application may be downloaded and installed on the user's smartphone, tablet, or other mobile electronic device. A key fob, which contains a receiver and transmitter, is also provided as an alternate operating device. When the application is activated, if an unauthorized person attempts to break into the user's vehicle is started, the vehicle transmits an alert notice to the user's devices. The user is then provided a brief, predetermined time period, such as 30 seconds, to deactivate the alert. If the alert is not deactivated by the user in this time period, both the vehicle and the user's devices transmit an alert to law enforcement.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a front view of a mobile electronic device with the mobile application component of the first exemplary embodiment installed, displaying the homepage 10, the alert notice 11, the panic button 12, the call police button 13, the cancel button 14, the device 18, and the visual display 19.

FIG. 2 is a front view of the key fob component of the first exemplary embodiment, displaying the key fob 15, the key ring 15A, the speaker 15B, the alert light 16, and the deactivation button 17.

FIG. 3 is a side view of the key fob component of the first exemplary embodiment, displaying the key fob 15, the key ring 15A, the speaker 15B, and the alert light 16.

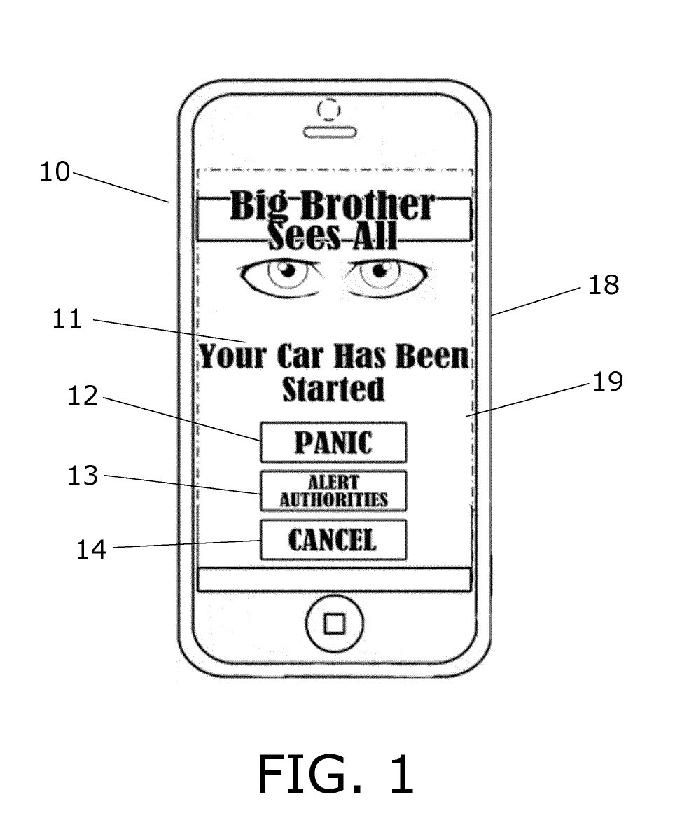

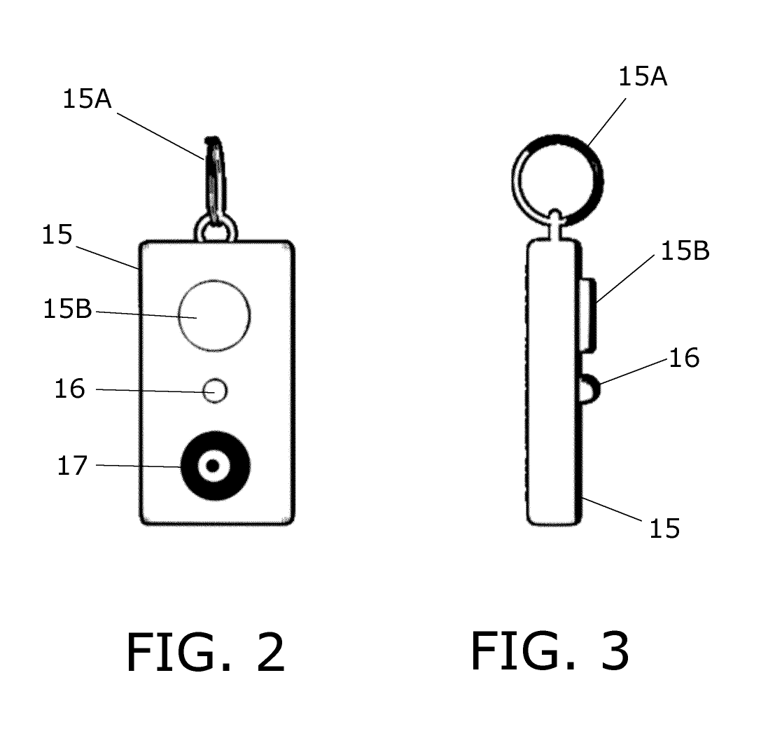

### DETAILED DESCRIPTION OF THE INVENTION

Referring now to the invention in more detail, the invention is directed to a mobile application for vehicle alarm notices and related system.

The first exemplary embodiment is intended for installation as original equipment by the manufacturer of the vehicle. An alternate embodiment, which is intended for installation as an after-market modification by the vehicle purchaser or by a repair or customizing shop, is contemplated.

To the greatest extent possible, as a cost saving measure the system utilizes vehicle communication and navigation equipment which is already part of the vehicle design, such as the components of an OnStar™ emergency communication system, or a Global Positioning System (GPS) device as a means of communicating with the mobile electronic device 18, fob 15, or police. The system provides means of detecting entry into the vehicle. The means of detecting entry into the vehicle preferably utilize motion sensors or any other suitable means of detecting entry. The system also provides means of detecting when the vehicle is started. The means of detecting when the vehicle is started preferably utilizes an electronic sensor to determine when the vehicle is powered on.

The first exemplary embodiment is comprised of a mobile application. The mobile application may be downloaded and installed on the user's smartphone, tablet, or other mobile electronic device 18. The first exemplary embodiment also provides a key fob 15 as an alternate operating device, which contains a means for communicating with the vehicle. The means are preferably a receiver and transmitter. When the application is activated, if an unauthorized person attempts to break into the user's vehicle, the vehicle alert system transmits an alert notice 11 to the key fob 15 and the user's mobile electronic device 18. The break-in attempt may be detected by a motion detector in the passenger compartment of the vehicle, or by some other means. The user is then provided a brief, predetermined time period, such as 30 seconds, to deactivate the alert. If the alert is not deactivated by the user in this time period, both the vehicle and the user's devices transmit an alert to law enforcement.

When the application is activated, a homepage 10 is displayed on the visual display 19 of the user's device 18. A panic button 12, a call police button 13, and a cancel button 14 are provided on the lower half of the homepage 10. Activating the application enables the user to select the panic button 12, which only sends an alert notice 11 to other devices such as the key fob 15 and the user's device 18, or the call police button 13, which will transmit an alert notice 11 to law enforcement if the alert is not subsequently deactivated within the predetermined time period.

When the vehicle's engine is started while the application is activated, the system immediately transmits a GPS query to obtain location information. When the location information is obtained, it is provided as part of the alert notice 11 sent to law enforcement, with the name and contact information of the user and the make, model, year, and color of the vehicle. The system periodically obtains updated location information from GPS, such as once every 60 seconds, and then transmits the updated location information to law enforcement and to the user until the alert is deactivated.

The key fob 15 provides a key ring 15A, a speaker 15B, an alert light 16, and a deactivation button 17. The alert notice 11 sent to the user's device 18 will also cause the alert light 16 to flash and an audible alert to be played by the speaker 15B, such as a pre-recorded voice message or a beeping sound. The user may press the deactivation button 17 to deactivate the alert within the predetermined time period.

The key fob 15 is preferably powered by a rechargeable battery and provides a Universal Service Bus (USB) port for the purpose of recharging the battery. The system components in the vehicle are preferably powered by the vehicle's electrical system.

Electronic components of the key fob 15 preferably include an internal ring antenna, a speaker 15B, an alert light 16, a transmitter and a receiver capable of operating on Radio Frequency (RF) or any one of several other short-range wireless communication protocols, a rechargeable battery, and a deactivation button 17. Other electronic components of the system, which are installed in the vehicle, preferably include a memory device, a microprocessor, an internal ring antenna, and a transmitter and receiver capable of operating on both the protocol of the key fob 15 and a cellular telephone protocol.

To use the first exemplary embodiment, the user activates the application by clicking on either the panic button 12 or the call police button 13. Subsequently, clicking on the cancel button 14 at any time will deactivate the application.

If the engine of the vehicle is started, the transmitter in the vehicle transmits a GPS query and transmits an alert notice 11 to the user. This causes the alert notice 11 to be displayed on the visual display 19 of the user's device 18. This also causes an audible alert to be played by the speaker 15B and a visual alert to be flashed by the alert light 16 on the key fob 15. The user may deactivate the alert by clicking on the cancel button 14, or by pressing the deactivation button 17 on the key fob 15.

The key fob 15 and the vehicle-mounted electronic components are preferably manufactured from rigid, durable materials, such as stainless steel, brass, plastic, and aluminum alloy. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A vehicle alarm system, comprising:
a. an alert system installed in a motor vehicle;
b. said alert system providing means for detecting entry into the motor vehicle;
c. said alert system providing means for detecting activation of the motor vehicle;
d. a mobile electronic device;
e. a fob;
f. said alert system providing means for communication with the mobile electronic device and the fob;
g. said mobile electronic device providing means for communication with the alert system;
h. said fob providing means for communication with the alert system;
i. a mobile application installed on the mobile electronic device;
j. said mobile application providing selectable options to send a notice to other devices, notify police, or cancel alerts;
k. said fob providing an alert light and a deactivate button;
l. said alert system being configured and programmed to send an alert to the mobile electronic device and fob when the alert system detects entry into the motor vehicle;
m. said alert system being configured and programmed to send an alert to the mobile electronic device and fob when the alert system detects activation of the motor vehicle;
n. said mobile application being configured and programmed to display an alert notice when the alert system sends an alert;
o. said fob alert light being configured and programmed to light up when the alert system sends an alert;
p. said mobile application being configured and programmed to cancel the alert sent by the alert system when the cancel alert option is selected;
q. said fob being configured and programmed to cancel the alert sent by the alert system when the deactivation button is pressed;
r. said alert system being configured and programmed to send an alert to law enforcement regarding entry into the motor vehicle or activation of the motor vehicle if the cancel alert option or deactivation button are not pressed within a predetermined period of time.

2. The vehicle alarm system of claim 1, wherein said fob further comprises a speaker;
said speaker being configured and programmed to make a sound when an alert is received from the alert system.

3. The vehicle alarm system of claim 1, wherein said alert system means of communication to the mobile electronic device, fob, and police utilizes a global positioning system device or emergency communications system installed in the motor vehicle.

4. The vehicle alarm system of claim 1, wherein said means for detecting entry into the motor vehicle utilizes motion sensors.

5. The vehicle alarm system of claim 1, wherein said means for detecting activation of the motor vehicle utilizes an electronic sensor to determine when the motor vehicle is powered on.

6. The vehicle alarm system of claim 1, wherein said predetermined period of time is equal to thirty seconds.

7. The vehicle alarm system of claim 1, wherein said mobile electronic device is configured and programmed to send an alert to law enforcement regarding entry into the motor vehicle or activation of the motor vehicle if the notify police option is selected on the mobile application.

8. The vehicle alarm system of claim 1, wherein said alert system utilizes a global positioning system to determine the location of the vehicle when an alert is activated; the location of the vehicle is including in the alert that is sent to the mobile electronic device, fob, and law enforcement.

9. The vehicle alarm system of claim 8, wherein the alert that is sent to the mobile electronic device, fob, and law enforcement further includes contact information for an owner of the motor vehicle, as well as the make, model, year, and color of the motor vehicle.

10. The vehicle alarm system of claim 8, wherein the alert system periodically obtains updated location information using the global positioning system; the updated location information is then sent to the mobile application, fob, and law enforcement in a new alert.
